(19) United States
(12) Patent Application Publication
(10) Pub. No.: US 2009/0035461 A1
(43) Pub. Date: Feb. 5, 2009

(54) Pulse Heating Methods and Apparatus for Printing and Dyeing

(75) Inventors: William Grier, Highland, CA (US); Ronald J. Breitag, Fontana, CA (US); Van Schmelzer, Escondido, CA (US)

Correspondence Address: FISH & ASSOCIATES, PC;ROBERT D. FISH, 2603 Main Street, Suite 1050, Irvine, CA, 92614-6232, US

(73) Assignee: COLOREP, INC., Rancho Cucamonga, CA (US)

(21) Appl. No.: 12/196,585

(22) Filed: Aug. 22, 2008

Related U.S. Application Data
(63) Continuation-in-part of application No. 11/844,180, filed on Aug. 23, 2007.
(60) Provisional application No. 60/839,956, filed on Aug. 23, 2006.

(51) Int. Cl. B41M 5/035; B41F 23/04

(52) U.S. Cl. 427/248.1; 118/724; 101/487

(57) ABSTRACT

The present invention provides apparatus, systems and methods in which a pulse heater is used to apply dyes to a receiver in a rotary heating processing equipment. The pulse heater is first applied to a belt and is then removed from the belt, creating a dissipating heat. A sandwiched receiver comprising of two dyed donor papers is then subjected to the dissipating heat off the belt and also subjected to a constant heat generated from a drum to cause a phase change of the dyes within the donor papers to phase change from a solid to a gas, so the receiver can absorb and capture the phase changed dyes for a more saturated and brilliant finish.

This application is a continuation in part of U.S. application Ser. No. 11/844,180 filed Aug. 23, 2007, which claims priority to U.S. provisional application Ser. No. 60/839,956 filed Aug. 23, 2006.

### FIELD OF THE INVENTION

The field of the invention is in sublimation printing and dyeing.

### BACKGROUND

Throughout the existence of mankind, humans have always found a way to decorate fabric with colors. Starting with hides and later woven and knitted materials, the traditional approach has been to liquefy the color by suspending it in a solution of water or some other fluid. The object to be dyed is then submersed in the solution or coated with it to produce the desired color.

Great skill was required to produce the desired color using this classic vat dyeing method. Great skill is still required to produce “dye lots” of the same color even with today's sophisticated equipment. Producing an exact color match is a product of re-creating the exact intersection of color concentration, energy (usually heat), object material, and processing time over and over in a chamber with constantly changing dynamics.

Skilled craftsmen all over the world dye more than 25 million tons of polymer based fabric annually using derivatives of these ancient skills. This process produces tons of clothing, home fashion products, and the most water pollution in the world. As new sources of fiber (mostly polymer based) are developed, the application of these ancient skills has become more difficult and problematic. The net effect is the decrease of matching yields and the increase of energy use and the production of ever greater volumes of dangerous effluents.

One solution is to use an extension of dispersed dye sublimation technology (hereafter referred to as DDS). DDS printing has been used for decades to print images on various fabrics and other receiving materials. In that process an ink is printed onto a donor transfer paper, and the paper is juxtaposed against the receiving material. When heat is applied to the outside surface of the paper, the special dyes explode into dye laden superheated air and drive the colorant into the receiving material. This use of super heated air—not water—as the carrying agent dramatically reduces pollution and energy use. The use of DDS technology for dyeing fabric and other materials is not new; it has been attempted for years with limited success for a number of reasons.

The primary problem with DDS is that the process cannot deliver sufficient color saturation to replicate water based solution dyeing. The common approach historically has been to place donor paper on both sides of the receiver; this process has not provided sufficient saturation and color replication to replace solution dyeing. Failure to color knit fabric when stretched and failure to color threads that roll during sewing and cutting has made two-sided printing in current equipment commercially unsatisfactory. Another problem is in the temperature of the receiver as it enters into the process. Generally, conventional starting temperature of backside donors are between 140° to 170° F., which is not sufficient enough to provide a great saturation of dye coverage. Furthermore, not all dyes are sublimatable with DDS. High energy dyes, while delivering stable brilliant colors, require much higher temperature to phase change which can destroy the receiver during sublimation. Because of this and other problems, DDS has never been used commercially in place of dyeing to cover large surface areas (e.g. printing of solids). The defect lines would simply be too obvious.

Another disadvantage of DDS printing is that double-sided printing yields colorations that are different from side to side even if the same ink is used. The reason is that the second application of heat tends to vaporize the first application of dye out of the paper and onto a take-up paper. See e.g. US 2003/0217685 to Mason et al. (pub. Nov. 27, 2003), and US 2003/0035675 to Emery at al. (pub. Feb. 20, 2003). These and all other publications referred to herein are incorporated by reference in their entirety.

Still another disadvantage of DDS printing is that it is entirely additive. Thus, if one prints a full color image on a yellow background, one must print on top of the yellow background, which distorts the colors of the image. Where multiple images or multiple passes are used, there can also be significant registering problems. See e.g., U.S. Pat. No. 6,393,988 to Gaskin (May 28, 2002).

This and all other referenced patents and applications are incorporated herein by reference in their entirety. Where a definition or use of a term in a reference, which is incorporated by reference herein is inconsistent or contrary to the definition of that term provided herein, the definition of that term provided herein applies and the definition of that term in the reference does not apply.

Thus, there is still a need for sublimation techniques to print solids and other integrated designs penetrating both sides of fabrics and other receiving materials, with good color consistency and vastly improved consistent color saturation.

### SUMMARY OF THE INVENTION

The present invention provides apparatus, systems and methods in which one or more dyes are placed on multiple donors, positioning at least two donors on opposite sides of the receiver; applying a pulse of heat energy to the assembled donors and receiver, then reducing the energy to complete placing and fixing the dyes.

Preferably, the first donor is physically separated from the second donor. They can be on opposite sides of the receiver. The first and second donors can be positioned manually or by automation.

The pulse of heat energy is calibrated, based on the weight and heat sync of the receiver, to be of duration only long enough to phase change the dye affixed to the donors. This pulse period is at least three seconds but may be longer based on the energy required to phase change different dyes and the mitigating factors of weight, fabric density and fiber heat sync.

In preferred embodiments, a sublimation process system accommodates a pulse heater and a pulse heating station to manufacture a fabric.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic of a preferred embodiment of a sublimation printing and dyeing apparatus.

FIG. 1A is a close up of element 140 from FIG. 1.

FIG. 2 is a close up of the processing equipment of FIG. 1.

FIG. 3 is a perspective view of a pulse heater.

FIG. 4 is an internal view of the heating elements of a pulse heater.

FIG. 5 is a schematic view of a reflector within the pulse heater of FIG. 5.

FIG. 6 is a schematic of an alternative preferred embodiment of a sublimation printing and dyeing apparatus.

### DETAILED DESCRIPTION

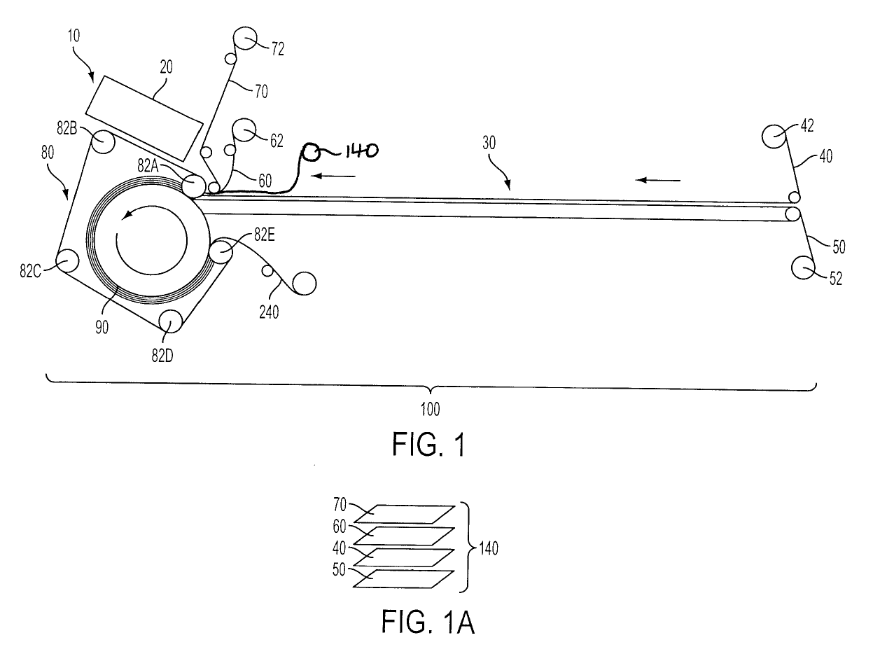

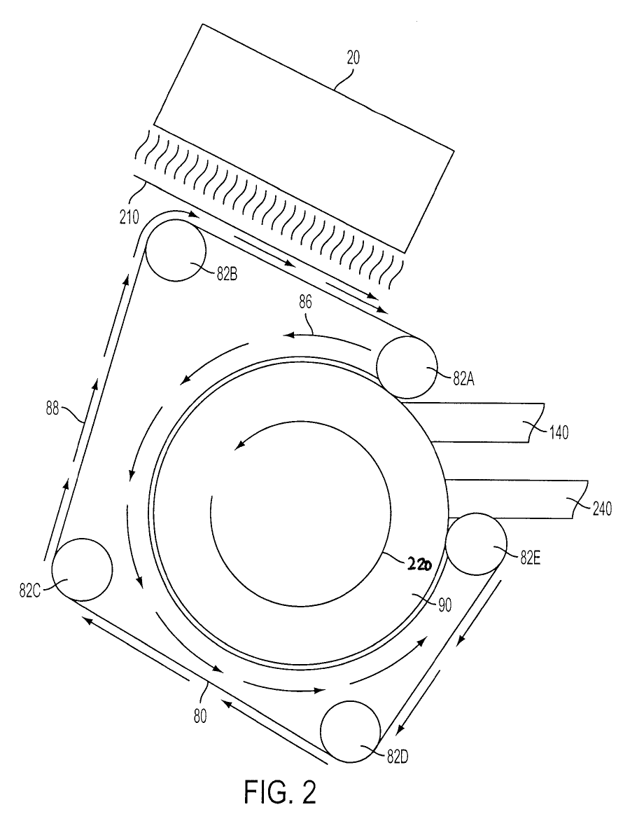

In FIGS. 1 and 2, processing equipment 100 generally includes rotary heating portion 10, pulse heater 20 and take-up belt 30.

Positioned on the equipment is a continuous take-up belt 30 that serves as a worktable. At one end, take-up belt 30 is attached to rotary heating portion 10 and on the opposite end take-up belt 30 takes up receiver 40 from receiver feed roll 42 and first donor 50 from first donor feed roll 52. The first donor 50 is placed against the take up belt as receiver 40 is placed on top of the first donor 50. As the processing equipment 100 starts to operate, take-up belt 30 moves receiver 30-first donor 50 and upon entry to the rotary hearing portion 10, take-up belt 30 also takes up second donor roll 60 from second donor feed roll 62 and tissue 70 from tissue feed roll 72 forming sandwiched receiver 140 that includes a top layer of tissue 70→second donor 60→receiver 40→first donor 50.

Rotary heating portion 10 preferably comprises calendar belt 80 and drum 90 to heat and press dyes from the donors onto the receiver. Calendar belt 80 preferably is situated around drum 80 and travels through positioners 82A-82E. As the processing equipment 100 operates, calendar belt 80 takes up the sandwiched receiver 140 and moves it against the side of drum 80 in a counter-clockwise direction from positioners 82A to 82E forming inner path 86, to generate a finished receiver 240. As the finished receiver 240 exists the processing equipment 100, calendar belt 80 moves along in a clockwise direction away from the drum 90 and from positioners 82E to 82D to 82C to 82B, and back to 82A to form outer path 88 and travels back again to the inner path 86 as shown in FIG. 2.

The orientation and placement of positioners 82A and 82E preferably enable calendar belt 80 to press sandwiched receiver 140 against drum 90. The number of positioners may vary depending on the processing equipment. It follows the length of the calendar belt varies according to the type of the machine. The width of the calendar belt preferably is at least 150 cm (60 in) wide but again, according to the different type of commercially viable processing equipment and/or the types of donor or receiver, the width of the belt may vary accordingly. Preferably, the belt is made from a flame-resistant meta-aramid material, more preferably made from the brand Nomex® fiber.

Pulse heater 20 preferably is located above outer path 88 between positioners 82B and 82A, which is also shown in more details in FIG. 2. When pulse heater 20 is in operation it generates intense heat against calendar belt 80 as the belt travels along outer path 88, clockwise from positioners 82B to 82A. In effect, the pulse heater is subjecting calendar belt 80 through a heat application passage 210. When take-up belt 30 moves receiver 40 and first donor 50 into rotary heating portion 10, calendar belt 80 is being heated briefly by pulse heater 20. As the belt 80 moves along rotary heating portion 10, kinetic energy is generated and is increased by the heat generated from the pulse heater. At the moment when sandwiched receiver 140 enters into the rotary heating portion 10, first donor 50 is pressed against drum 90 as second donor 60 is pressed against calendar belt 80. Preferably, as calendar belt 80 moves along, it travels clockwise into the inner path portion 86 and still carries the remaining heat generated from the pulse heater 20. The calendar belt 80 pressed the sandwiched receiver 140 by making direct contact with tissue 70, which is positioned against second donor 60 and pressed down against receiver 40 and first donor 50, which is pressed against drum 90. In essence, the sandwiched receiver 140 is being subjected to a phase change passage 220 in which the kinetic energy generated from the heat application passage 210 is being transferred from calendar belt 80 so that second donor 60 undergoes a phase change to allow the dyes to be transferred brilliantly into receiver 40. This process subjects the sandwiched receiver to a dissipating yet intense heat from the belt as it enters the rotary heating portion. Preferably, drum 90 simultaneously generates a constant heat to phase change first donor 55 by allowing dyes transferred onto receiver 40 and enhances the second donor 60. This allows two donors to be simultaneously processed onto a receiver for brilliant and uniformed print and dye application. The length of phase change passage is preferably at least 20% as long as heat transfer passage. In some cases, the application of dissipating heat to the sandwiched work receiver can happen no more than five seconds before the application of constant heat generated from drum 90. As sandwiched receiver 140 continues to travel in rotary portion 10, it is still being heated by the belt and the drum, this process allows the dyes on the second and first donor to continue to phase change so they are gradually absorbed or captured by the receiver brilliantly and deeply.

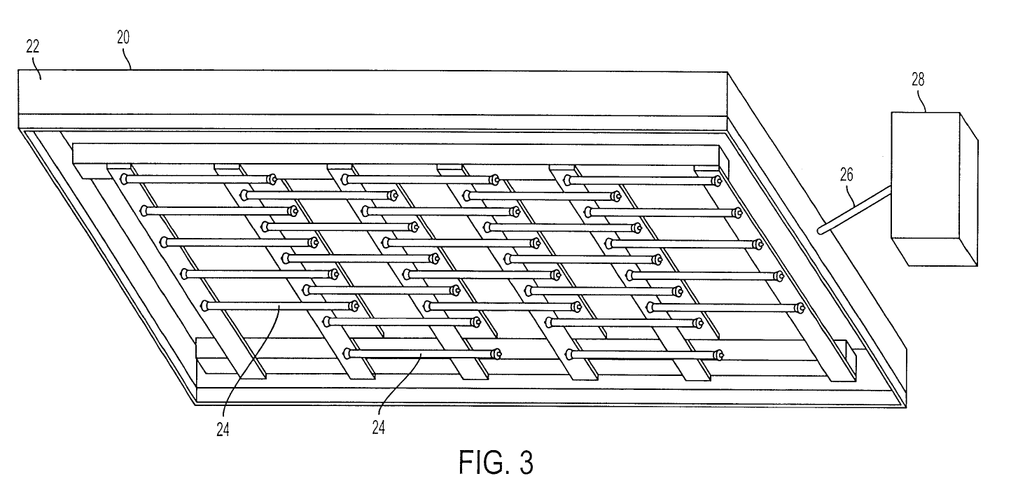

Pulse heater 20 preferably is a heat source that can generate intense heat uniformly applied across the width of calendar belt 80. As shown in FIG. 3, pulse heater 20 preferably comprises housing 22, a series of heating elements 24 stored within housing 22; power outlet 26; and controls 28.

Preferably housing 22 has top 23 with optional edges 25 to allow an open enclave to house the heating elements and allow them to be exposed. The edges 25 of housing 22 preferably is at least five (5) inches in height to accommodate the heating elements, but they can vary according to the types of heating elements. It is contemplated that the width of the housing is approximately the same as the width of the belt since the heat distributed from the pulse heater should be evenly applied to the belt. Constructions may vary as to the depth of the housing and in general, housing 22 preferably is made of a durable material, such as galvanized steel, that can withstand temperature of at least 650° F., more preferably at least 550° F., and most preferably at least 450° F.

Preferably, a pulse heater is attached directly above the calendar belt at an angle of preferably at least 45° and preferably located at least 7 cm (3 in) away from belt 70. It is contemplated that the angle and the distance may be more or less depending on the processing equipment and how much heat is required. The pulse heater is preferably located across the entire width of the calendar belt as to distribute heat evenly across such width. However, depending on the equipment, the width of the belt and the type of receiver, it is contemplated that the pulse heater can be located closer or further away from the belt.

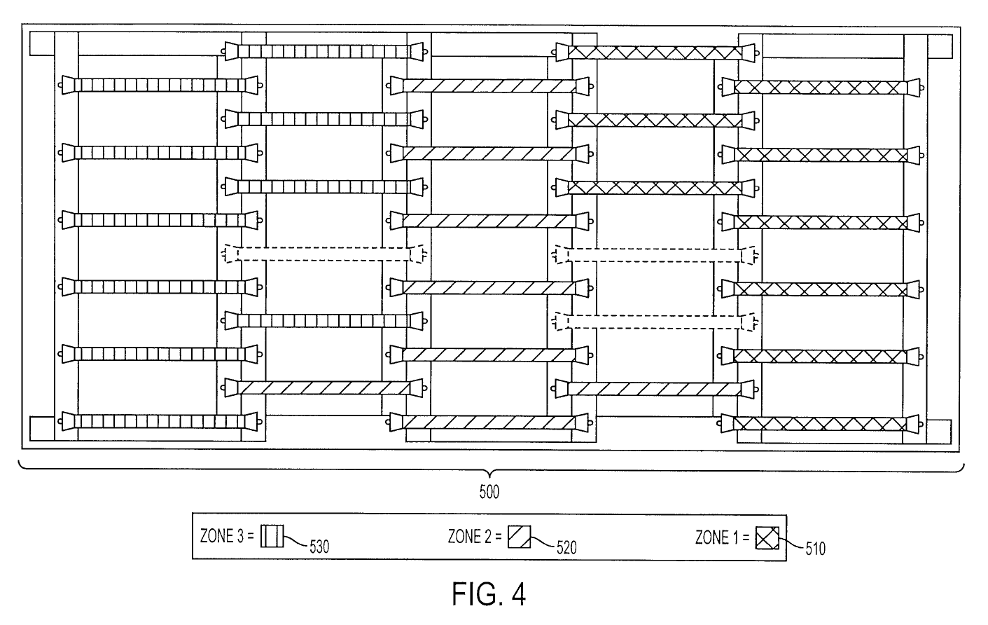

Heating elements 24 preferably can be made from a variety of heat sources, such as overlapping quartz tubes. In a preferred embodiment shown in FIG. 4, heating elements 24 comprises a series of quartz tubes 500 that can be divided into three zones, 510, 520 and 530 Each quartz tube preferably generates at least 500 watt, or more or less. Depending on the number and positioning of the tubes, the power of the tubes can be increased or decreased, such that even tubes generating 1000 watt or more may be used. Each zone is controlled separately. This enables temperature distribution across belt 70 easily controlled by raising and lowering the power output to each zone, and/or by removing tubes from the matrix. It is also contemplated that other types of heat source can be used and a gradient method such is employed. Pulse heat can be generated with any conventional heat source. The heat source can be infrared light, UV light, or any other heat source as long as the source adequately heats up the donor to a temperature that allows the donor to be more readily applied to the receiver.

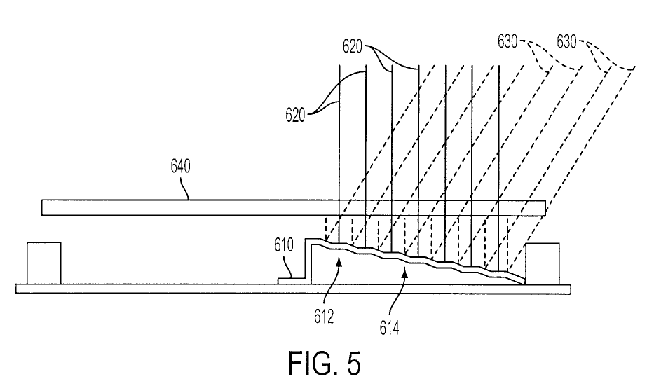

Temperature can also be distributed evenly at the edges of the belt by placing a reflector 610 behind a quartz tube 640, as shown in FIG. 5. Reflector 610 can be angled, but is preferably corrugated, alternating between parallel sections 612 and angled sections 614. Parallel sections 612 reflect heat waves 620 directly towards the belt, and angled sections 614 reflect heat waves 630 towards an edge of the belt.

In preferred embodiments, the average temperature applied across the belt from the pulse heater generally varies from 300° F. to 650° F. depending on the properties of the belt, receiver, donor, and dyes used. The weight and density of the receiver, the sublimating temperature of the dye, and the speed of the belt all can be a contributing factor of the temperature. Furthermore, the speed of the belt can greatly influence the size, number, and orientation of the pulse heater. The temperature preferably is evenly applied across the width of the belt. More preferably the temperature of the belt does not fluctuate more than 35° F., most preferably no more than 25° F.

The dwell time of the pulse heater exposure to the belt is preferably between 10-15 seconds. However, it is contemplated that a slow moving belt might necessitate longer and less intense exposure to a pulse heater, and a fast moving belt might necessitate a short and more intense exposure to a pulse heater.

Control 28 in FIG. 3 is used to control the temperature, the time, and the type of heat generated by the pulse heater 20. Power outlet 26 and controls 28 can be located as part of the existing sublimating equipment or they can be a separate unit depending on the need. Integrating the pulse heater's power outlet and controls with the existing machine allows for a simpler and more uniformed approach. However, having the power outlet and the controls separately enables the pulse heater to be movable.

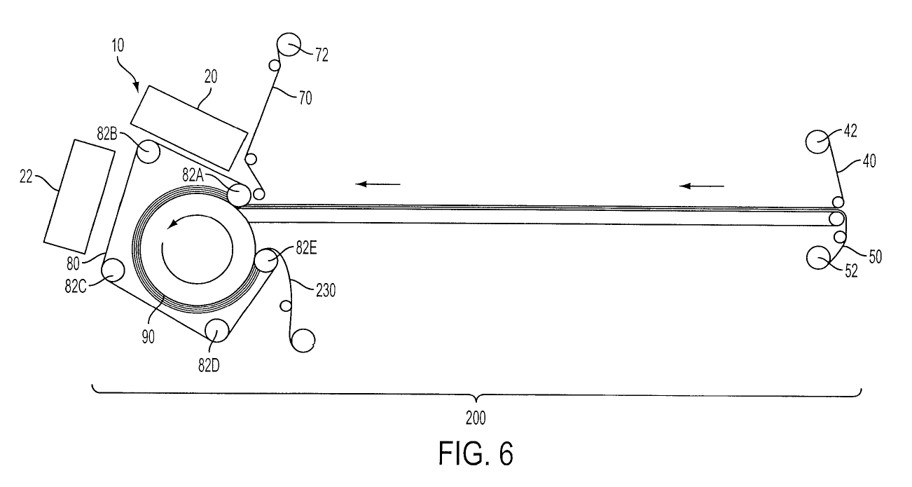

In another preferred embodiment, only one or first donor 50 is taken up by the belt as shown in FIG. 6. Tissue 70 is needed to protect receiver 40 from being exposed directly to belt 80. Before tissue-receiver-first donor enters into the belt 80, pulse heater 20 heats up the belt between positioners 82B and 82A. As tissue-receiver-donor enters into the belt, the dissipating heat from the belt causes a phase change on the first donor even though the first donor is against the drum. There is enough dissipating heat to cause the phase change for the dyes to penetrate deeper into the receiver to generate a finished receiver 230.

Despite a current preference for continuous processing, it is also contemplated that embodiments of the inventive subject matter could be practiced in a discontinuous manner, for example with sandwiched work pieces being assembled, and heat and pressure applied in a piece by piece manner. In that regard it is specifically contemplated that the receiver could be cut from a bulk material.

A preferred configuration is to construct a pulse heater as a separate piece and attach said pulse heater on to existing cylinder based machines, such as Monti Antonio™ and Practix™ that could be easily modified to operate according to the inventive concepts described herein. Another preferred configuration is to build a cylinder based machine that has a pulse heater constructed within and be integrated into the machine's controls and power system.

The location of the pulse heater can vary according to the need of the finished product. Thus, while it is preferable to have a single pulse heater located between positioners 82B and 82A, it is contemplated that the pulse heater can be located anywhere along the belt to manipulate the saturation and finish of the dyes. Depending on the processing equipment, pulse heater can be placed either under the calendar belt or over the calendar belt, as long as one side of the belt is being preheated.

It is also preferred to have one or more pulse heater as shown in FIG. 6. Besides having pulse heater 20 located above belt 80 between positioners 82B and 82A, an additional pulse heater 22 between positioners 82C and 82B can be easily installed. There can be even a pulse heater located between positioners 82C and 82D (not shown). Having one or more pulse heater can generate more intense heat for a brilliant finish on receivers that would otherwise be difficult to process, i.e. carpet.

The key aspect of the present inventive subject matter is that the pulse heater adds additional energy to the kinetic energy already generated from the moving calendar belt to give off an intense yet brief heat. The combination of this heat off the belt and the additional heat generated from the drum will break up the bonds of the donor dyes for a more saturated sublimation process as the sandwiched receiver enters into a rotary heating element. Since the receiver is on the other side of the donor, it is not damaged by the high temperature. When a second donor is placed on the opposite side of the calendar belt where the receiver is, the pulse heater also heats up and prepares the second donor to saturate for deeper dye dispersion and penetration. Thus, it is contemplated that heat sufficient to pulse heat would be applied to two sides of the calendar belt for a length of time that is directly proportional to the length of the belt and the speed at which it operates. The speed preferably depends on the characteristics of the receiver and donor(s). For a more permeable receiver, the speed can be faster and for a less permeable or thicker receiver, a slower process maybe needed. Before entering into the rest of the sublimation process, the calendar belt cools down back to normal sublimation temperature. Sublimating heat on any given side is preferably provided for a dwell time of between 30 and 120 seconds, more preferably between 40 and 75 seconds, and most preferably about 45 seconds. Sublimation temperature is preferably no more than 400° F., and more preferably less than 600° F.

Drum 90 provides a consistent heat source that is even around its surface, maintaining a temperature that allows the receiver to better absorb any sublimated dyes from the donor. Preferably, drum 90 is a hot heater drum. It is, however, contemplated that the drum can be any other type of heating unit as long as heat can be applied. Other contemplated examples include a tunnel-shaped heating zone, a heated cylinder, or also by means of a heated plate (iron or warm press).

The temperature generated by the drum to heat the donor is preferably at least 250° F. and more preferably at least 350° F., and most preferably at least 385° F. The temperature differential between the drum where it contacts a donor is preferably 450° F. warmer than the temperature of calendar belt 80, more preferably 300° F. warmer, even more preferably 200° F. warmer, and most preferably 100° F. warmer than calendar belt 80. This temperature differential is adjusted according to the type of donor and how the dyes or other type of chemical properties on the donor phase change to attach to the receiver.

Tissue 70 can be selected from known take up tissues used in the industry. In contrast to the prior art, the tissues are not used in the current embodiments to absorb dyes that pass entirely through the receiver 40 and opposite donor 50 or 60. That is unnecessary because the donor materials are nearly or entirely impermeable to the passage of dyes. Instead the tissue 70 in embodiments of the present invention serve to protect the mechanical parts from excess colorant.

First and second donors 50, 60 can be selected from known donor papers, or other materials used in the industry. The donor material can be any thin sheet that is substantially impassible to dye from side to side, but which has a surface to which a dye can be temporarily held. Preferably, a donor is generally an object that holds a dye in solid form that, when a certain amount of heat is applied to the donor, changes phase and travels towards the receiver. Preferably, donors include high energy dyes which provides for more stable and steadfast colors. It should also be appreciated that the terms “dye” and “dyes” are used in the broadest possible sense to include inks, and indeed any chemical composition that can be transferred to a receiving material to color that material. Thus, the terms “dye” and “dyes” include chemical compositions that can change color depending upon temperature or other conditions, and even chemical compositions that are colorless when applied, but turn color upon exposure to moisture, or high temperature. Furthermore, the terms “dye” and “dyes” refer to any temperature-sensitive release agent that stains, dyes, or otherwise changes a visual property of the receiver once the dye is heated beyond a temperature threshold. Preferably a dye phase changes from a solid state to a gas state, but a dye can phase change from a solid to a liquid state in certain embodiments.

To that end, donors 50, 60 can be printed with solid colors, or at least relatively large areas of solids and/or large repeating patterns. It is especially contemplated that donors 55, 50 can be printed with solids or large repeating patterns having contiguous areas of at least 10 cm², 50 cm², 100 cm², 200 cm² or 400 cm². To avoid the color shifts that are prevalent with ink jet and other printed donors, it is preferable when printing solids, or patterns including a single color, to use a roller coater (not shown) to ink one or both of the donors 50, 60. By printing both donors 50, 60 in this manner, receivers can be produced that have the same color of solids on both sides, one color of solid on one side and a different color of solid on the other side, a solid on one side and a pattern on the other, and so forth. Printing patterns on both sides is also entirely feasible, although back-to-back registration of the images is still somewhat problematic. Complex patterns and even photographic or other images can also be printed, with third, fourth, and other colors. Indeed, to simplify the drawing, FIG. 1 should be interpreted generically as including all such combinations.

Receiver 40 can be any material that can receive sublimation printing. This includes most especially, polyesters and other synthetic polymers or fibers that absorb dyes at high temperature and pressure, with currently preferred receiver materials including the true synthetics or non-cellulosics (e.g., polyester, nylon, acrylic, modacrylic, and polyolefin) blends, and so forth. It is contemplated that receiver materials could also include natural fibers (e.g., cotton, wool, silk, linen, hemp, ramie, and jute), semi-synthetics or cellulosics (e.g., viscose rayon and cellulose acetate), but currently available colorants do not “take” very well with such fibers. It is further contemplated that temperature receivers such as pymides like Tyvek® and others will be available for sublimation using this apparatus. Receivers can be flexible or rigid, bleached or unbleached, white or colored, woven or non-woven, knitted or non-knitted, or any combination of these or other factors. Thus, a receiver could, for example, include a woven material on one side and a non-woven or different woven material on the other side. Among other things, receivers are contemplated to include fabrics and fibers used for clothing, banners, flags, curtains and other wall coverings, and even carpets.

The advantages of the methods and systems disclosed herein are enormous. First of all, by preheating the calendar belt, the sublimation process generally becomes more advanced. The advantage of using the pulse heater allows for greater saturation and use of different dyes. While all sublimation dyes are dispersible, not all dispersed dyes can be sublimated. “Sublimation dyes” are dyes commonly used in the industry that phase change to attach to a receiver at a standard sublimation temperature or sublimate that does not destroy or damage the receiver. In contrast, “high-energy dyes” are dyes which require much higher energy and temperature than standard sublimation temperatures an therefore can destroy or damage the receiver. Thus, high energy dyes could not be used effectively in the past, since the receiver would either be severely burned, melted and reformed into a non-pliable material. The present inventive subject matter uses a pulse heater that converts the heat energy and uses it to break the bonds of the high energy dyes and prepares the dispersed side by creating a phase change without transmitting the heat energy to the receiver. Thus, as the sublimation process continues, the high energy dyes are dispersed onto the receiver without producing a higher temperature that can destroy the receiver. The receiver is not damaged by using higher temperature and thus higher energy dyes can be used. This enables the receiver to be ready to receive dyes. Not only will the dyes and prints be more uniformly and consistently applied, they penetrate deeper into the receiver to reduce bleeding or smudging. The printing and dyeing quality overall is significantly improved.

Furthermore, the pulse heater allows for multiple images to go through on the same receiver without significant registering problems. By splitting up the dying process into two parts from an instantaneous phase change stage to a gradual absorption stage, the different images or dyes will not bleed or interfere with each other with the pulse heater as the pulse heater preps the receiver more efficiently. Consequently, the pulse heater can also generate double-sided printing that is more uniform and consistent in dye dispersion.

Another advantage of the present inventive subject matter is presented in the convenience and ease of installation. The pulse heater can accommodate a variety of DDS machines. This allows flexibility in not having to replace existing machinery and increase costs. Thus, as the quality improves, the overall production costs do not have to increase.

It should be apparent, however, to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced.

What is claimed is:

1. A method of printing on both sides of a receiver comprising:
positioning first and second donors on opposite sides of a receiver;
applying a first heat source to a thermal capacitor;
removing the first heat source from the thermal capacitor to generate a dissipating heat;
subjecting the first donor to the dissipating heat; and
applying a second heat source to the second donor.

2. The method of claim 1, further comprising positioning a reflector on a first heat source.

3. The method of claim 1, wherein the thermal capacitor is thermally resistant and flame resistant.

4. The method of claim 1, wherein the thermal capacitor is a calendar belt.

5. The method of claim 1, wherein the first heat source applies a temperature differential of less than 25° F. across a width of the thermal capacitor.

6. The method of claim 5, wherein the width is at least 150 cm (60 in).

7. The method of claim 5, wherein an average temperature applied across the width is no less than 300° F.

8. The method of claim 7, wherein an average temperature applied across the width is no more than 650° F.

9. The method of claim 7, wherein an average temperature applied across the width is adjusted according to a weight of the receiver.

10. The method of claim 7, wherein an average temperature applied across the width is adjusted according to a density of the receiver.

11. The method of claim 1, wherein the first heat source is at most 100° F. more than the second heat source.

12. The method of claim 1, wherein the first heat source is generated from overlapping a plurality of heating elements.

13. The method of claim 12, wherein the heating elements are quartz tubes.

14. The method of claim 1, wherein the first heat source is at least 7 cm (3 in) away from the thermal capacitor.

15. The method of claim 1, wherein the step of applying the first heat source to a thermal capacitor lasts no longer than 15 seconds.

16. The method of claim 1, wherein the second heat source is a drum.

17. The method of claim 1, further comprising positioning a tissue between the first donor and the thermal capacitor.

18. The method of claim 1, wherein at least part of the step of applying the second heat source is concurrent with the step of subjecting the first donor to the dissipating heat.

19. The method of claim 1, wherein the step of applying the second heat source happens at least 5 seconds behind the step of subjecting the first donor to the dissipating heat.

20. The method of claim 1, wherein the each of the first and second donors comprise a sublimation dye.

21. The method of claim 1, wherein the first donor comprises a high-energy dye.

22. The method of claim 1, further comprising depositing a temperature-sensitive release agent to the first donor.

23. The method of claim 1, wherein the receiver comprises a synthetic fiber.

24. The method of claim 1, wherein the receiver comprises a clothing fabric.

25. The method of claim 1, wherein the receiver comprises a carpet.

26. The method of claim 1, wherein the receiver comprises a banner and a flag fabric.

27. A method of printing high energy dyes on a receiver comprising:
depositing a first high-energy dye on a donor;
positioning the donor on a receiver;
applying a heat source to a thermal capacitor;
removing the heat source from the thermal capacitor to generate a pulse energy; and
applying the pulse energy to the donor to phase change the high-energy dye onto the receiver.

28. A method of printing high energy dyes on both sides of a receiver comprising:
depositing first and second high-energy dyes on first and second donor, respectively;
positioning the first and second donors on opposite sides of a receiver;
applying a first heat source to a thermal capacitor;
removing the first heat source from the thermal capacitor to generate a pulse energy applying the pulse energy to the first donor; and
applying a second heat source to the second donor.

29. An apparatus for printing on both sides of a receiver comprising:
a thermal capacitor that travels through a heat transfer passage and a phase change passage;
a heater that heats the heat transfer passage;
a donor provider that feeds a first donor on a first side of a receiver into the phase change passage, wherein the first donor abuts the first side of the receiver;
a drum that heats a second donor on a second side of the receiver within the phase change passage.

30. The apparatus of claim 29, wherein the thermal capacitor is a belt.

31. The apparatus of claim 29, wherein the heater comprises a plurality of heating elements.

32. The apparatus of claim 31, wherein the heating elements are quartz tubes.

33. The apparatus of claim 29, wherein the heater generates a temperature of at least 300° F.

34. The apparatus of claim 29, wherein the heater generates a temperature of no more than 650° F.

35. The apparatus of claim 29, further comprising a reflector disposed to reflect a heat from the heater towards an edge of the thermal capacitor.

36. The apparatus of claim 29, wherein the heat transfer passage lasts at least 15 seconds.

37. The apparatus of claim 29, wherein the phase change passage lasts at least 20% as long as the length of the heat transfer passage.

38. The apparatus of claim 29, wherein the drum generates a temperature of no more than 450° F.

39. The apparatus of claim 29, wherein the first and second donors comprises a sublimation dye.

40. The apparatus of claim 29, wherein the first and second donors comprises a high-energy dye.

41. The apparatus of claim 29, wherein the thermal capacitor is made with a meta-aramid.

42. An apparatus for printing on both sides of a receiver comprising:
a belt that travels through a heat transfer passage and a phase change passage;
a heater that heats the heat transfer passage; and
a donor provider that feeds a first donor on a first side of a receiver into the phase change passage, wherein the first donor abuts the receiver.

43. An article of clothing manufactured at least in part using the method according to claim 1.

44. A carpet manufactured at least in part using a method according to claim 1.
